(19) United States
(12) Patent Application Publication
(10) Pub. No.: US 2003/0226719 A1
(43) Pub. Date: Dec. 11, 2003

(54) Gravity reacting anti-rollerback brake

(76) Inventor: Arthur J. Yeager, Kailua, HI (US)

Correspondence Address: OFFICE OF THE STAFF JUDGE ADVOCATE, U.S. ARMY MEDICAL RESEARCH AND MATERIEL COMMAND, ATTN: MCMR-JA (MS. ELIZABETH ARWINE), 504 SCOTT STREET, FORT DETRICK, MD, 21702-5012, US

(21) Appl. No.: 10/425,034

(22) Filed: Apr. 29, 2003

Related U.S. Application Data
(60) Provisional application No. 60/375,815, filed on Apr. 29, 2002.

(51) Int. Cl. B60T 1/00

(52) U.S. Cl. 188/4 R; 188/2 F

(57) ABSTRACT

This invention relates to a gravity reacting brake system. According to the invention there is provided a brake system comprising a pair of graded brake cam structures disposed on opposite ends of a connecting rod. Connecting rod and cams are operatively disposed adjacent wheels via lever assembly mount. The natural pull of gravity and the configuration of the cams operate to allow passage of wheels in both directions when on flat surfaces and in only a single direction when on an incline. When on an incline, gravity operates to dispose cams relative to the wheels such that rotation of wheels in one direction is hindered by a thickening of cam body caused by rotation of cam about its axis. The system also includes adjustment means for setting the incline angle at which cams will operate to stop wheel rotation in the undesired direction.

This application claims the benefit of priority from U.S. provisional Application Serial No. 60/375,815, filed Apr. 29, 2002.

### I. FIELD OF THE INVENTION

The present invention relates to braking systems. More particularly, the present invention relates to gravity-actuated braking systems.

### II. BACKGROUND OF THE INVENTION

The invention of the wheel greatly revolutionized the transportation of persons and materials. As will be appreciated, wheels must have brakes or a means to cease the rotation of the wheel to stop the movement of the vehicle to which they are attached. With vehicles powered manually, such as strollers, carts, stretchers, and the like, the provision of braking mechanisms poses unique challenges. As will be appreciated, without a braking mechanism, these manually powered vehicles cannot be left unattended on slopes or non-flat surfaces in view of the fact that the force of gravity will induce the wheels (and thus the vehicle) to roll in the descending direction. This problem is a particularly concern with manually or arm-powered wheelchair devices, for example, where the safety of the patient is of utmost importance.

As will be appreciated, caregivers attending to a wheelchair occupant sometimes need to leave the occupant unattended to, for example, open a door or prepare a car lift. In these periods, the occupant may need to prevent the wheelchair from descending an incline, or from undergoing what is know in the art as a “rollback.” Some occupants do not have the stamina or strength to prevent a rollback on inclines.

In an effort to prevent rollbacks, some prior artisans crafted wheelchairs with wheel locks for locking the large, rear wheels against rotation. A wheel lock assembly is typically mounted to the frame of the wheelchair adjacent each rear wheel. Each wheel lock assembly includes a hand operated lever which is connected by mechanical means to a braking member for engaging the tread at the periphery of the wheel. Accordingly, when the lever is disposed in a free wheeling position, the braking member is spaced away from the wheel and the tire so as to allow the wheel to rotate freely. Likewise, when the handle is moved to the locked position, the brake member is moved into contact with the tire with sufficient force so as to press into, and temporarily deform the outer surface of the tire to frictionally hinder rotation of the tire.

One of the drawbacks with these prior art rear wheel locks is that they require either a large manual effort or a long throw to lock the wheels from further rotation. Another drawback of these prior art devices is that the braking mechanism prevents any rotation of the tires in either direction. As will be appreciated, it is desirable to allow the wheels to move in the ascending direction while inhibiting movement in the descending direction, such as with a patient being transported or ascending an incline. For example, if the operator were to stop propelling the wheelchair up a hill and relax, gravity would urge the chair to roll backwards. Similarly, when the operator removed his hands from the wheels to push open a door, the pushing tends to force the wheelchair in the opposite direction. Even with automatic doors, the operator is forced to press against a button to actuate the door. In many instances, the brake would have to be engaged to prevent a rollback and by the time the operator disengages the brake, the door would close again.

Accordingly, it is desirable to provide a one-way braking mechanism to provide for only rotation of the wheels in the forward direction. In an effort to meet this need, some prior artisans crafted “hill holder” mechanisms, or one-way clutches, to the hub of the rear wheels. These prior art clutches were relatively expensive and mechanically complex. Other hill holders have been devised which also incorporate a wheel lock assembly. However, these combination devices suffer from numerous drawbacks as well. For example, U.S. Pat. No. 4,887,830 to Frough et al discloses a wheelchair with a combined wheel lock and hill holder. The device uses a cam to engage the brake. However, the device is spring loaded and must thus be manually engaged and disengaged. Once engaged, the wheelchair is hindered from movement in the rearward direction completely. Furthermore, once engaged, the drag of the device on a user's intended direction is a noted drawback.

More significantly, with these prior art wheelchairs, the braking device needs to be disengaged anytime the wheels are to be rolled in the rearward direction. The constant burden of manually engaging and disengaging a device depending on whether the occupant is on level ground or desires to move rearwardly is a significant drawback to such devices. As will be appreciated, for wheelchair occupants of limited cognitive ability, upper body strength, dexterity, range of motion, or coordination, manually engaging and disengaging a safety device is not a viable option.

The forgoing underscores some of the problems associated with prior art braking systems. Furthermore, the foregoing highlights the long-felt, yet unresolved need in the art for a braking system which automatically engages and disengages features based on the user's terrain.

### III. SUMMARY OF THE INVENTION

The present invention overcomes the aforementioned drawbacks in the art and offers new advantages as well. Accordingly, it is an object of the invention to provide a braking system which automatically engages and disengages features based on the user's terrain. It is also an object of the invention to provide an automatic anti-rollback brake. It is another object of the invention to provide a braking system which can be retrofit for existing devices.

In accordance with these and other objects of the invention, there is provided a gravity reacting brake. According to one aspect of the invention, the gravity reacting brake is adjustable to engage at a predetermined incline.

According to another aspect of the invention, the braking system comprises a brake cam. In accordance with this aspect of the invention, the brake cam is preferably graded such that it increases in gripping power as it is engaged. The grade is preferably such as to allow movement in a desired direction, and even more preferably such as to provide for disengagement when on flat surfaces to allow movement in both directions. In a preferred embodiment, the graded brake cam comprises a durable material, such as a material selected from the group consisting of metal alloys that are lightweight and strong. The brake cam also preferably utilizes interchangeable brake pads.

According to another aspect of the invention, there is provided an anti-rollback braking system. In accordance with this aspect of the invention, the anti-rollback braking system may be for a wheelchair. In a preferred embodiment, the anti-rollback braking system comprises a pair of graded brake cams. The brake cams are preferably operationally disposed on respective rear wheels of the wheelchair. A lever assembly mount is preferably used to connect the braking system to the wheelchair. The lever assembly mount is preferably used to secure the brake device to the lower frame of the wheelchair, in an area just forward of the larger wheel. The lever assembly is also preferably of a clamp design to allow fore and aft adjustment. Preferably, the lever assembly includes a connecting rod which provides the fulcrum for each of the graded brake cams. More preferably, the lever assembly ensures simultaneous engagement of both wheels by the braking system.

According to another aspect of the invention, the system includes an adjuster or adjustment mechanism which allows the braking system to be adjusted to only engage at or above a predetermined incline angle.

According to another aspect of the invention, the system includes a release mechanism that allows a user to disengage the rollback protection.

Given the following enabling description of the drawings, the apparatus should become evident to a person of ordinary skill in the art.

### IV. BRIEF DESCRIPTION OF THE DRAWINGS

The present invention is described with reference to the accompanying drawings. In the drawings, like reference numbers indicate identical or functionally similar elements.

FIG. 1 is a plan view of a graded brake cam assembly according to the present invention.

FIG. 2 is a partial plan view of a wheelchair gravity reactive anti-rollback brake according to the invention.

FIG. 3 is a partial side view of a wheelchair gravity reactive anti-rollback brake according to the invention.

FIGS. 4A-C depict a lever release mechanism according to the invention.

### V. DETAILED DESCRIPTION OF THE DRAWINGS

The present invention is based, in part, on the concept that a gravity reacting braking system can prevent undesired movement of objects disposed on an incline. While the present invention will be described in connection with a wheelchair, it will be readily apparent to one of ordinary skill in the art that the present invention can be applied to a multiplicity of fields and uses. In particular, the present invention may find use for preventing the movement of other manually powered vehicles such as carts, stretchers, strollers and the like.

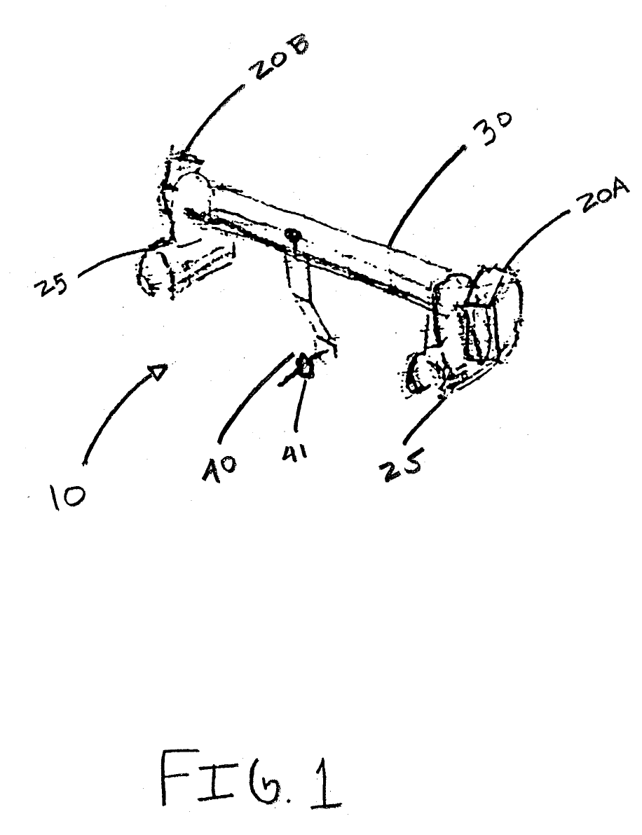

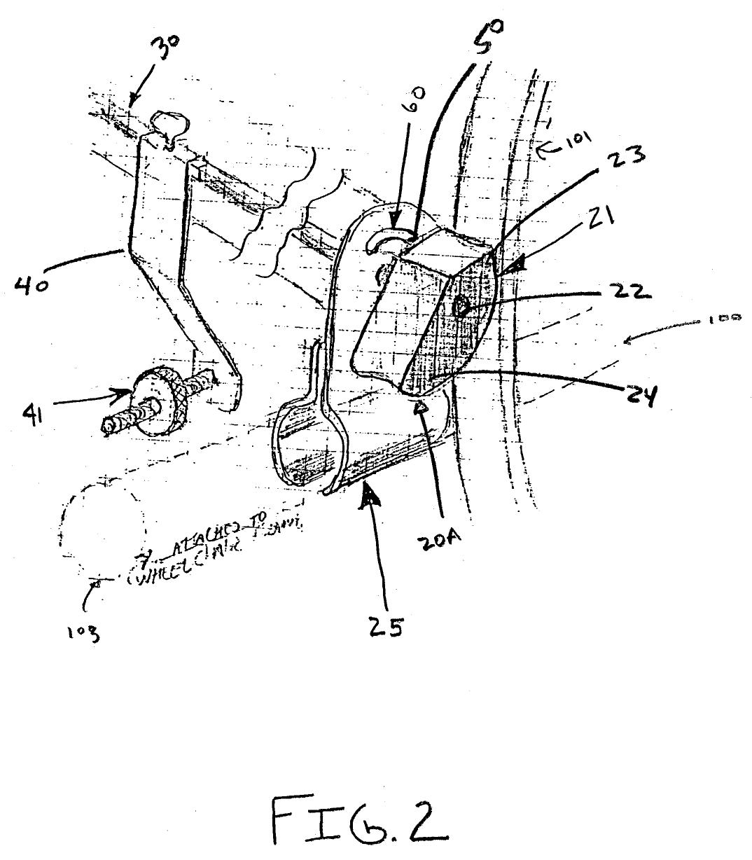

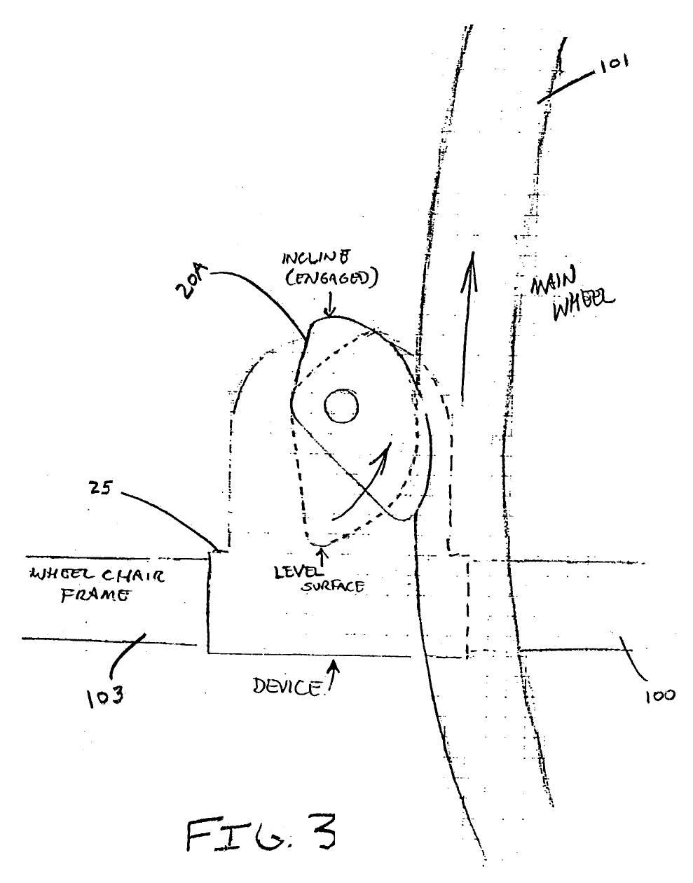

FIGS. 1-4 depict a presently preferred embodiment of the invention. In this embodiment, gravity reacting anti-rollback brake system 10 may be coupled to wheelchair 100. The invention contemplates that the simple construction and configuration of brake system 10 is such that the device may be adapted to retrofit almost any existing wheelchair. The brake system is preferably attached to the frame of the chair in an area just forward of the larger wheel.

According to the presently preferred embodiment, brake system 10 preferably utilizes a pair of graded brake cams 20A, 20B, one for each rear wheel 101 of chair 100. Although this embodiment features brake cams operatively positioned to engage the outer surface of the tire of the wheels, any alternative positioning which allows the cams to hinder rotation of a body, axle, or the like is understood to be within the scope of the invention. Graded brake cams 20A, 20B are graded such that their gripping power is increased as the face 21 of the cam is engaged. Any suitable configuration of brake cams is understood to be within the scope of the invention. For example, it is well within the skill of the ordinary artisan to adapt a configuration which allows for free movement of the wheels in both directions when on flat terrain and prevents movement in one direction when a predetermined incline is reached.

Graded brake cams 20A, 20B are preferably disposed on opposite ends of connecting rod 30. Preferably, connecting rod 30 extends through and serves as the fulcrum for each brake cam. Further, according to this embodiment of the invention, connecting rod 30 and brake cams 20A, 20B are configured to allow the weight of rod 30 to be such that gravity keeps the cams operatively positioned. One of ordinary skill in the art will appreciate this as the principal behind so-called “broom holders” that use the weight (force) of the broom to keep the holder engaged.

Preferably, connecting rod 30 also serves to insure simultaneous engagement of both rear wheels 101, 102. Simultaneous and uniform engagement is preferable to prevent lateral movement, misalignment, or spinning of the wheelchair.

Presently preferred brake cams comprise a durable material, such as lightweight and strong metal alloy(s). According to the invention, brake pads can be used with brake cams to accommodate a range of wheels and environments. Alternatively, to prevent wear, it is possible to construct brake cams from a strong unitary material, such as metal, and provide the outer cam surface with serrations or teeth for grip. Likewise, brake pads may comprise any suitable material. If used, brake pads are preferably interchangeable and thus may be easily replaced when worn.

To attach brake system to the wheelchair, a lever assembly mount 25 is provided. The assembly mount 25 preferably couples to the wheelchair to provide rigid support for the brake system. The assembly mount preferably is used to secure the brake device to the lower frame 103 of the chair in an area just forward of the larger wheel 101. The lever assembly 25 in this embodiment is of a clamp design to allow fore and aft adjustment. Adjustment is desirable when two brake cams are used to help ensure simultaneous engagement of the cams with the wheels. The lever assembly 25 may be mechanically mounted to chair via a nut and bolt, or any other suitable means. Any assembly which allows for secure connection to a vehicle while allowing gravitational disposition of the cam(s) is understood to be within the scope of the invention. Preferably, the assembly will also provide for simultaneous engagement if a plurality of cams are used.

Disposed between brake cams 20A, 20B on connecting rod 30 is adjustment mechanism or adjuster 40. The adjuster 40 preferably comprises an adjustable weight 41 which may be positioned to influence the slope at which the cams will contact the tires. The adjuster 40 according to this embodiment of the invention has a weight which can be adjusted to cause cams to engage at a specified slope angle or desired sensitivity.

As will be appreciated, gravity keeps the weight at a constant 180 degrees from the brake cam fulcrum 22 regardless of the angle of the wheelchair. The cams are configured such that on level surfaces, the cam is not in contact with the wheel thereby allowing freewheeling in a forward and rearward direction. However, the changing of the angle of the wheelchair frame (i.e., via an incline) in relation to the constant, gravity-induced brake-cam position results in a diminishing clearance between the braking surface of cam surface and the rear wheel. Since the grade of the cam lessens 23 in favor of the intended direction of movement, the cam does not impede movement of the rear wheel. However, the grade of the cam increases 24 in the opposite direction. The cam's movement towards the wheel periphery directly correlates to the wheelchair's rotation around the hub of the main wheels. Once in contact with the wheel, any rearward rotation leads to an increasing grip by the cam as it thickens when rotated about its axle 22. Accordingly, the cam serves to prevent further rotation of the wheels in that direction.

Extending from the brake cam is short rod 50 that moves through slotted arc 60 in lever assembly mount 30. The arc provides the travel limits of the brake cam's rotation and ultimately the stopping force from the immobile wheelchair frame.

In the present embodiment, brake 10 is configured and disposed to prevent rearward movement of wheelchair 100 when wheelchair 100 is on an incline. According to this embodiment, depending on the user's needs and abilities, the brake 10 can be configured to engage at a specific incline. By contrast, according to another preferred embodiment, and as will be appreciated by one of ordinary skill in the art, the brake system can be configured and disposed on a wheelchair to allow the user to move rearwardly and not forwardly when on an incline (for users who prefer or need to move up inclines backwards). It is well within the ability of one of ordinary skill in the art armed with the present specification to modify the shape, configuration or disposition of the system to achieve the intended purpose.

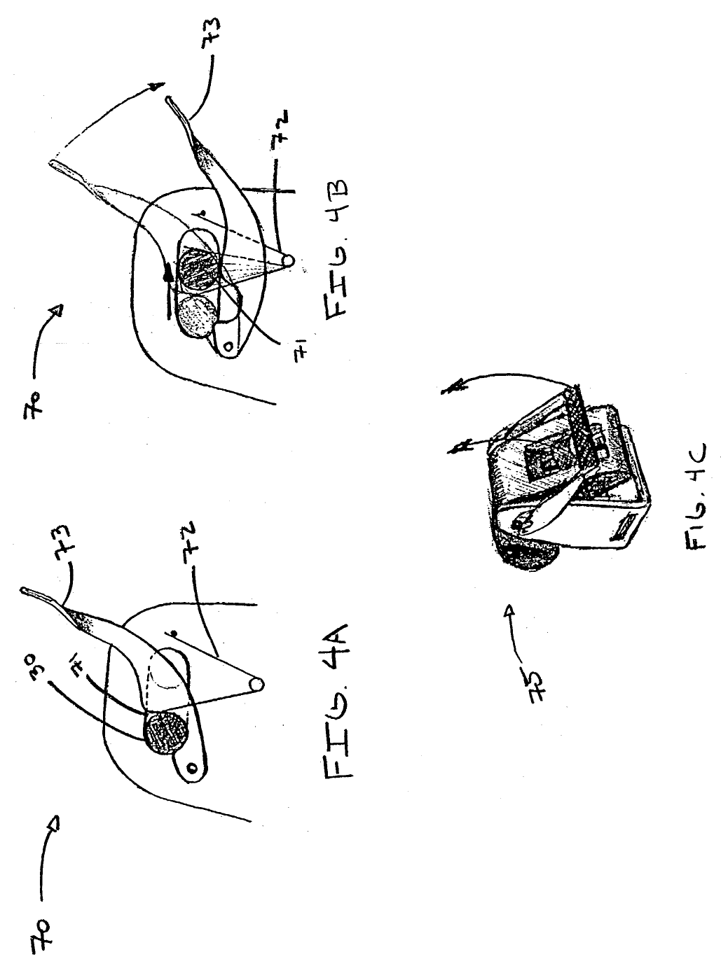

According to the present invention, the brake system 10 may include a release mechanism 70 for releasing the rollback protection when needed, for example, when having to move back from an outwardly opening automatic door. A presently preferred embodiment is depicted in FIGS. 4A-C. As shown, the connecting rod 30 or an axle 22 of cam is disposed in a slit 71 and spring biased by spring 72 to keep the brake cams operationally positioned relative to their respective wheels. The rod 30 is connected to lever 73 which allows the operator to actuate the lever and overcome the spring bias to move the rod across the slit and carry the brake cams a distance from their respective wheels to ensure the cams do not engage the wheels and restrict movement. This type of release mechanism may be suited for use with any type of vehicle and positioned in the back of a wheelchair or on the handle of a stroller if desired. For example, a cable could be attached to the spring release to provide for actuation from an area away from the connecting rod or axle with, for example, the lever assembly 75 of FIG. 4C. However, it is well within the ability of one of ordinary skill in the art to provide a mechanism which moves the cam brakes out of operational position with their respective wheels.

Those skilled in the art will appreciate that various adaptations and modifications of the above-described preferred embodiments can be configured without departing from the scope and spirit of the invention. Therefore, it is to be understood that, within the scope of the appended claims, the invention may be practiced other than as specifically described herein.

We claim:

1. A brake system comprising:
a brake cam gravitationally disposed adjacent a rotatable body;
said brake cam being gravitationally disposed in a first position when said rotatable body is on a level surface, wherein there is a distance between said brake cam and said rotatable body, thereby allowing said rotatable body to rotate in a forward and backward direction;
said distance being affected by the orientation of said rotable body such that said brake cam contacts said rotatable body when said rotatable body reaches a predetermined incline;
said brake cam being graded to allow rotation of said rotatable body in one direction and not the opposite direction when said brake cam is in contact with said rotatable body.

2. The brake system of claim 1, wherein said rotatable body is free to rotate in a forward direction and not a backward direction when said brake cam is in contact with said rotatable body.

3. The brake system of claim 1, wherein said rotatable body is free to rotate in a rearward direction and not a forward direction when said brake cam is in contact with said rotatable body.

4. The brake system of claim 1, further comprising an adjuster for setting said predetermined incline.

5. The brake system of claim 4, wherein said adjuster comprises an adjustable weight.

6. The brake system of claim 1, wherein said rotatable body is a wheel.

7. The brake system of claim 6, wherein said cam contacts an outer surface of said wheel.

8. The brake system of claim 7, wherein said outer surface is a tire tread.

9. The brake system of claim 8, wherein said brake system comprises a pair of cams operatively associated with respective rotating bodies.

10. The brake system of claim 9, wherein said rotating bodies are rear wheels of a wheelchair.

11. The brake system of claim 1, further comprising a release mechanism for disengaging said brake cam from said rotatable body to allow rotation of said rotatable body in both directions.

12. The brake system of claim 1, wherein said rotatable body is a wheel on a manually powered vehicle.

13. The brake system of claim 12, wherein said vehicle is selected from the group consisting of stretchers, strollers, carts, and wheelchairs.

14. A gravity reacting anti-rollback brake system for a vehicle comprising:
a connecting rod;
a pair of brake cams disposed on opposite ends of said rod, said rod configured to allow gravity-induced positioning of said brake cams; wherein said brake cams are positioned adjacent but not in contact with respective wheels when said vehicle is on a flat surface and positioned in contact with respective wheels when said vehicle is at a predetermined angle;
said brake cams being graded to prevent movement of said wheels in one direction while allowing movement of said wheels in an opposite direction when in contact with said wheels;
means for connecting said brake system to said vehicle.

15. The brake system of claim 14, further comprising a means for adjusting the orientation of said system for setting the predetermined angle at which the cams contact their respective wheels.

16. The brake system of claim 15, wherein said means for adjusting comprises and adjustable weight.

17. The brake system of claim 16, further comprising means for disengaging said cams from contact with said wheels after reaching or exceeding said predetermined angle.

18. The brake system of claim 17, wherein said means for disengaging comprises a lever actuatable to overcome a spring bias and move said connecting rod away from said wheels.

19. A wheelchair comprising:
a frame assembly;
a seat for supporting a user, said seat being supported by said frame assembly;
a plurality of wheels connected with the frame assembly for rollably supporting the frame assembly; said plurality of wheels including a pair of rear wheels;
a connecting rod operationally attached to said frame assembly;
a pair of cam brakes disposed on opposite ends of said connecting rod; said cams each being gravitationally disposed adjacent respective rear wheels such that said cams contact said wheels when said wheelchair is on an inclined surface;
said cams being graded so as to allow rotation of said wheels in a first direction but not in a second direction when in contact with said rear wheels.

20. The wheelchair of claim 19, further comprising an adjustable weight attached to said connecting rod for setting an angle of incline at which gravity will cause contact between said cam brakes and said rear wheels
